(19) United States
(12) Patent Application Publication
(10) Pub. No.: US 2004/0227026 A1
(43) Pub. Date: Nov. 18, 2004

(54) Waste treatment apparatus

(76) Inventor: Mark H. Butler, New South Wales (AU)

Correspondence Address: COLLEN IP, THE HOLYOKE MANHATTAN BUILDING, 80 SOUTH HIGHLAND AVENUE, OSSINING, NY, 10562, US

(21) Appl. No.: 10/792,605

(22) Filed: Mar. 3, 2004

Related U.S. Application Data
(63) Continuation-in-part of application No. 09/869,180, filed on Nov. 2, 2001, now Pat. No. 6,732,962.

(51) Int. Cl. B02C 18/16

(52) U.S. Cl. 241/235

(57) ABSTRACT

A cutting mechanism (108) for shredding waste has a planetary gearbox which carries four cutting heads (109) that are in close proximity to one another. The cutting heads (109) are rotated in the same direction by the gearbox (110) so that at a shredding zone between opposed portions of adjacent cutting heads (109), the opposed portions are moving in opposite directions.

### CROSS REFERENCE TO RELATED APPLICATIONS

The following application is a Continuation in Part of application Ser. No. 09/869,180, filed on Nov. 2, 2001.

### SUMMARY OF INVENTION

This invention relates to the treatment of waste material and more particularly to a cutting mechanism for shredding waste.

For the sake of convenience, the invention will be described in relation to cutting mechanisms for waste treatment apparatus for use in the sterilisation of infectious and/or quarantined waste. However, it will be appreciated that the invention is not limited to that particular use and as it will find application in treating other types of waste which may or may not require sterilisation.

Accordingly to one aspect of the invention there is provided a cutting mechanism for shredding waste comprising a planetary gearbox carrying a plurality of rotating cutting heads in close proximity to one another.

Preferably, the planetary gearbox has a plurality of planet gears and further including a stub axle projecting out of the gearbox from each planet gear and a rotating cutting head on each stub axle. The stub axles may be equally spaced from the centreline of the gearbox and equally spaced from one another.

In a preferred form of the invention, the cutting heads are rotated in the same direction by the gearbox so that at a shredding zone between opposed portions of adjacent cutting heads, the opposed portions are moving in opposite directions.

Preferably, each cutting head has a body portion having base adjacent the gearbox and a free end face remote from the gearbox and a plurality of cutting edges spaced around the periphery of the body portion.

### BRIEF DESCRIPTION OF DRAWINGS

In order that the invention may be more readily understood and put into practical effect, reference will now be made to the accompanying drawings in which:

FIG. 1 is a schematic side view of a waste treatment device incorporating a cutting mechanism according to an embodiment of the invention;

FIG. 2 is a front elevational view of the cutting mechanism depicted in FIG. 1;

FIG. 3 is a side elevational view of the cutting head and gearbox of the device shown in FIG. 2; and

FIG. 4 is a perspective view of the cutting head and gearbox of the device shown in FIG. 2;

### DETAILED DESCRIPTION OF PREFERRED EMBODIMENTS OF INVENTION

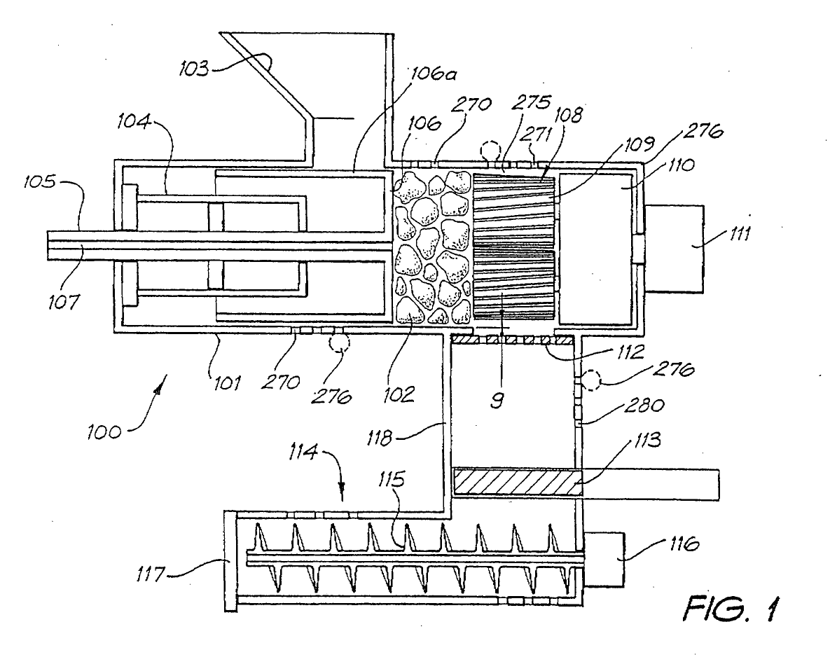

As shown in FIG. 1 an on-site waste treatment apparatus 100 includes a primary treatment chamber 101 into which waste 102 is fed through a chute 103. The primary chamber 101 includes an advance mechanism in the form of, for example, a hydraulic ram 104. The shaft of the ram 105 may include a central bore 107 through which steam is fed. The steam emerges through the head of the ram 106. The head 106 includes an elongated skirt 106a which serves to seal the chamber 101 from the chute 103 when the ram is sufficiently advanced.

After waste is introduced into the chamber, it may be sealed and evacuated prior to any introduction of steam to promote uniform penetration of steam into the mass of waste 102.

Owing to the action of the ram, waste matter 102 is forced under pressure against a shredding or cutting mechanism 108 located within the primary chamber 101. The cutting mechanism includes a hydraulic motor 111 which drives a planetary gear box 110, the planet gears of which are coupled to two or more rotating cutting heads 109.

Pressurised or super-heated steam (“steam”) may be provided directly into the chamber 101 before and during the operation of the cutting mechanism in various ways. Additionally steam may be piped or otherwise provided to the chamber, either by vents 270 along the length of the chamber or by vents 271 in the area of the cutting heads 109. These vents, like others depicted in these examples are supplied by jackets or pipes 276 suggested in FIG. 1, but not shown for clarity.

The temperature may be monitored in the chamber 101 over time. Waste is maintained in the chamber 101 at a specified temperature, for a specified time before the advance mechanism, and cutting mechanism 109 are activated. This may be done with automated process control equipment.

Waste material 102 which is forced by the ram into contact with the cutting heads 109 is thoroughly macerated and ejected from the chamber 101 through a grate 112 when the cycle is completed. The entire process may be auto recorded for record keeping purposes. The grate is replaceable and interchangeable with other grates so that the size of the grate openings can be varied to suit different types of waste or replaced for maintenance purposes. The narrow gap “g” between the cutting heads and the interior o the chamber helps control the site of the ejector.

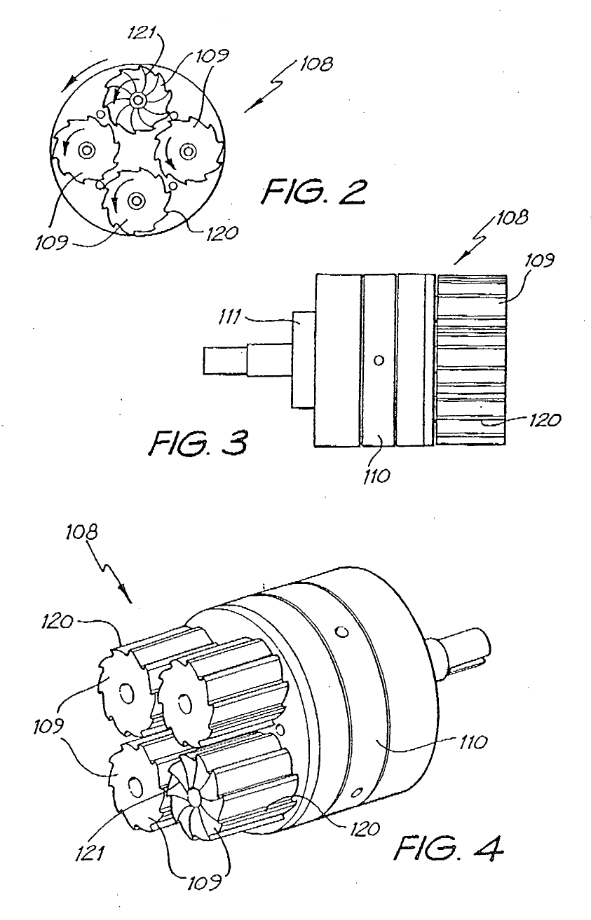

The cutting or shredding mechanism 108 according to an embodiment of the invention is shown in greater detail in FIGS. 2 to 4. As shown in these FIGS., the cutting heads 109 are mounted on the stub axles or shafts of the rotating planet gears of a planetary gear box 110. The stub axles are equally spaced from the centre line of the gear box 110 and equally spaced from each other and are so disposed around the gear box 110 that the clearance between the outside diameter of the cutting circle of the heads 109 and the inside diameter of the primary chamber 101 creates a narrow gap or shredding zone which limits the size of the waste which is ejected through the grate 112. The preferred number of cutting heads 109 is between two and four although more cutting heads 109 may be mounted on an appropriately designed planetary gearbox, as required. Each of the cutting heads 109 is fashioned from a hardened steel to provide maximum durability and service life.

Each cutting head 109 has a body portion having a base adjacent the gear box 110 and has cutting blades or edges 120 which run the full length of each head 109. A cutting head 109 may also include cutting edges 121 on a face or a portion of the face of the head 109. A small clearance is provided between adjacent heads to provide a shredding zone there between. Owing to the action of the planetary gearbox, the gear box itself 110 rotates in the same direction as the cutting heads but at a different speed to the cutters 109. As can be seen in FIG. 2, the heads 109 are rotated in the same direction by the gear box 110 so that at a shredding zone between opposed portions of adjacent cutting heads 109, the opposed portions are moving in opposite directions.

The clearance 275 between the chamber wall 276 and the cutting head 109 is kept small so that the waste is broken down by the heads 109 into small pieces. Waste leaving the primary chamber 101 enters an optional secondary processing chamber 118. Additional steam can be provided by vents 280 into this secondary chamber 118 which is sealable with an isolation gate valve 113 located beneath the grating 112. Shredded and steamed waste collects on the gate valve 113 after it passes through the grate 112. The grate valve is kept closed during the secondary steaming process and is opened after the secondary steaming process has been completed.

A discharge chamber 114 is located directly beneath the isolation gate valve 113 and receives the shredded and steam treated waste when the gate valve 113 is opened. Within the discharge chamber 114 there is an agitator or auger 115 that is driven by a motor 116 to tumble the waste which is again steamed during this step of the process which takes places as the primary main process is being repeated on the next batch of waste in the primary chamber 102 with the gate valve 113 closed.

The tertiary process in the discharge chamber 114 ensures that the waste material is thoroughly treated. When this cycle is complete, the discharge door 117 is opened and the shredded and sterilised material is ejected by the agitator 115 into a waste container for disposal.

Various modifications may be made in details of design and construction without departing from the scope and ambit of the invention.

1. A cutting mechanism for shredding waste comprising a planetary gearbox carrying a plurality of rotating cutting heads in close proximity to one another.

2. A cutting mechanism according to claim 1 wherein the planetary gear box has a plurality of planet gears and further including a stub axle projecting out of the gear box from each planet gear and a rotating cutting head on each stub axle.

3. A cutting mechanism according to claim 1 wherein the gearbox has a centreline and the stub axles are equally spaces from the centreline and equally spaced from one another.

4. A cutting mechanism according to claim 1 wherein the cutting heads are rotating in the same direction by the gear box so that a shredding zone between opposed portions of adjacent cutting heads, the opposed portions are moving in the opposite directions.

5. A cutting mechanism according to claim 1 having four cutting heads.

6. A cutting mechanism according to claim 1 wherein the gearbox is driven by a hydraulic motor.

7. A cutting mechanism according to claim 1 mounted within a chamber having an inlet for receiving waste to be shredded and an outlet for discharging shredded waste.

8. A cutting mechanism according to claim 1 wherein each cutting head has a body portion having base adjacent the gear box and a free end face remote from the gear box and a plurality of cutting edges spaced around the periphery of the body portion.

9. A cutting mechanism according to claim 8 and including cutters on the end face of each head.

10. A cutting mechanism according to claim 8 wherein each cutting head has 10 cutting edges.

11. A cutting mechanism according to claim 8 wherein the cutting edges around the periphery of the body portion extend from the base to the free end of each head.

12. A cutting mechanism according to claim 11 wherein the cutting edges are generally parallel to the center line of each head.
